(19) United States
(12) Patent Application Publication
(10) Pub. No.: US 2015/0235156 A1
(43) Pub. Date: Aug. 20, 2015

(54) Enabling Capacity On Demand In A Computing System Using A Calendar

(71) Applicant: LENOVO ENTERPRISE SOLUTIONS (SINGAPORE) PTE. LTD., SINGAPORE (SG)

(72) Inventors: Shiva R. Dasari, Austin, TX (US); Douglas W. Oliver, Round Rock, TX (US); Mehul M. Shah, Austin, TX (US); Wingcheung Tam, Austin, TX (US)

(21) Appl. No.: 14/183,871

(22) Filed: Feb. 19, 2014

(51) Int. Cl. G06Q 10/06; G06F 9/50

(52) U.S. Cl. CPC G06Q 10/06314; G06F 9/5005

(57) ABSTRACT

Enabling capacity on demand in a computing system using a calendar, including: receiving, by a resource management module, a request to purchase capacity on demand, the request including a cumulative amount of time for capacity on demand; receiving, by the resource management module, one or more calendar entries identifying requested periods of time for capacity on demand; and allocating, by the resource management module, capacity on demand in dependence upon the cumulative amount of time for capacity on demand and the requested periods of time for capacity on demand.

### BACKGROUND OF THE INVENTION

1. Field of the Invention

The field of the invention is data processing, or, more specifically, methods, apparatus, and products for enabling capacity on demand in a computing system using a calendar.

2. Description Of Related Art

Modern computing systems include a variety of resources for handling the computing loads placed on the computing system. The processing loads placed on a computing system may vary at different points in time, as processing loads may be heavy during one period of time while processing loads are light during another period of time. In order to properly size a computing system, without requiring that the computing system be required to include enough resources to handle the heaviest of processing loads that are experienced infrequently, it is desirable for a computing system to include the ability to utilize additional computing resources as needed.

### SUMMARY OF THE INVENTION

Methods, apparatuses, and products for enabling capacity on demand in a computing system using a calendar, including: receiving, by a resource management module, a request to purchase capacity on demand, the request including a cumulative amount of time for capacity on demand; receiving, by the resource management module, one or more calendar entries identifying requested periods of time for additional capacity; and allocating, by the resource management module, capacity on demand in dependence upon the cumulative amount of time for capacity on demand and the requested periods of time for additional capacity.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 sets forth a block diagram of automated computing machinery comprising an example computer useful in enabling capacity on demand in a computing system using a calendar according to embodiments of the present invention.

FIG. 5 sets forth a flow chart illustrating an example method for enabling capacity on demand in a computing system using a calendar according to embodiments of the present invention.

FIG. 6 sets forth a flow chart illustrating an additional example method for enabling capacity on demand in a computing system using a calendar according to embodiments of the present invention.

FIG. 7 sets forth a flow chart illustrating an additional example method for enabling capacity on demand in a computing system using a calendar according to embodiments of the present invention.

### DETAILED DESCRIPTION OF EXAMPLE EMBODIMENTS

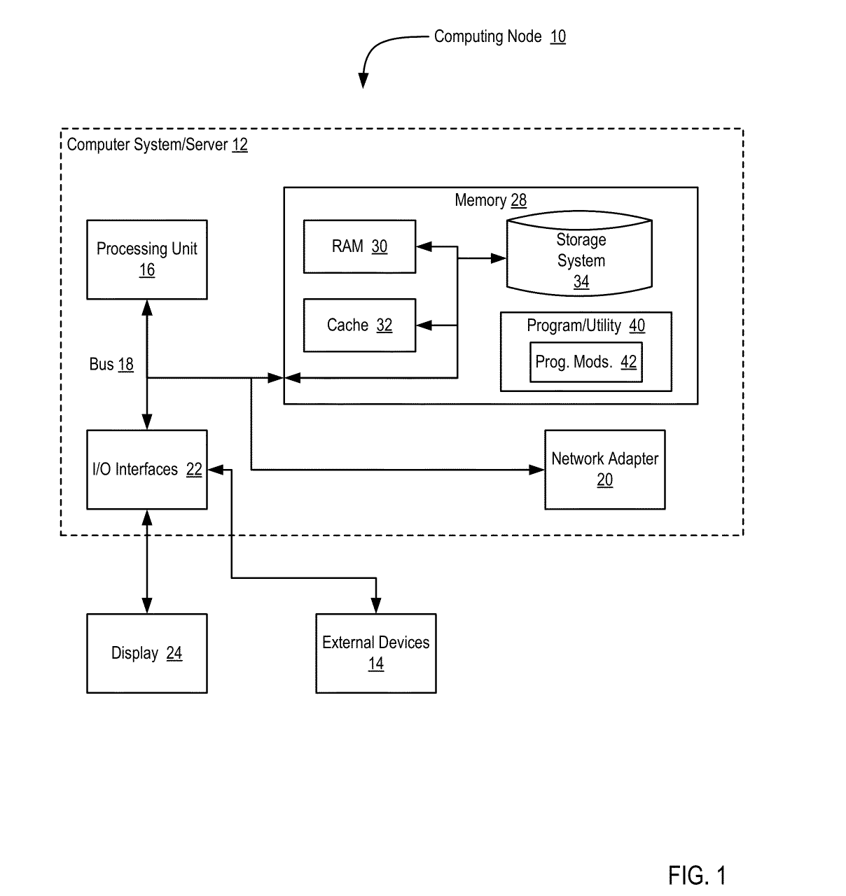

Example methods, apparatuses, and computer program products for enabling capacity on demand in a computing system using a calendar in accordance with the present invention are described with reference to the accompanying drawings, beginning with FIG. 1. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (‘SaaS’): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (‘Paas’): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (‘IaaS’): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1, a schematic of an example of a cloud computing node is shown. Cloud computing node (10) is only one example of a suitable cloud computing node and is not intended to suggest any limitation as to the scope of use or functionality of embodiments of the invention described herein. Regardless, cloud computing node (10) is capable of being implemented and/or performing any of the functionality set forth hereinabove.

In cloud computing node (10) there is a computer system/server (12), which is operational with numerous other general purpose or special purpose computing system environments or configurations. Examples of well-known computing systems, environments, and/or configurations that may be suitable for use with computer system/server (12) include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (12) may be described in the general context of computer system executable instructions, such as program modules, being executed by a computer system. Generally, program modules may include routines, programs, objects, components, logic, data structures, and so on that perform particular tasks or implement particular abstract data types. Computer system/server (12) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server (12) in cloud computing node (10) is shown in the form of a general-purpose computing device. The components of computer system/server (12) may include, but are not limited to, one or more processors or processing units (16), a system memory (28), and a bus (18) that couples various system components including system memory (28) to processor (16).

The bus (18) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (‘ISA’) bus, Micro Channel Architecture (‘MCA’) bus, Enhanced ISA (‘EISA’) bus, Video Electronics Standards Association (‘VESA’) local bus, and Peripheral Component Interconnect (‘PCI’) bus.

Computer system/server (12) typically includes a variety of computer system readable media. Such media may be any available media that is accessible by computer system/server (12), and it includes both volatile and non-volatile media, removable and non-removable media.

System memory (28) can include computer system readable media in the form of volatile memory, such as random access memory (‘RAM’) (30) and/or cache memory (32). Computer system/server (12) may further include other removable/non-removable, volatile/non-volatile computer system storage media. By way of example only, storage system (34) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (18) by one or more data media interfaces. As will be further depicted and described below, memory (28) may include at least one program product having a set (e.g., at least one) of program modules that are configured to carry out the functions of embodiments of the invention.

Program/utility (40), having a set (at least one) of program modules (42), may be stored in memory (28) by way of example, and not limitation, as well as an operating system, one or more application programs, other program modules, and program data. Each of the operating system, one or more application programs, other program modules, and program data or some combination thereof, may include an implementation of a networking environment. Program modules (42) generally carry out the functions and/or methodologies of embodiments of the invention as described herein.

Computer system/server (12) may also communicate with one or more external devices (14) such as a keyboard, a pointing device, a display (24), etc.; one or more devices that enable a user to interact with computer system/server (12); and/or any devices (e.g., network card, modem, etc.) that enable computer system/server (12) to communicate with one or more other computing devices. Such communication can occur via Input/Output (‘I/O’) interfaces (22). Still yet, computer system/server (12) can communicate with one or more networks such as a local area network (LAN), a general wide area network (‘WAN’), and/or a public network (e.g., the Internet) via network adapter (20). As depicted, network adapter (20) communicates with the other components of computer system/server (12) via bus (18). It should be understood that although not shown, other hardware and/or software components could be used in conjunction with computer system/server (12). Examples, include, but are not limited to: microcode, device drivers, redundant processing units, external disk drive arrays, RAID systems, tape drives, and data archival storage systems, etc.

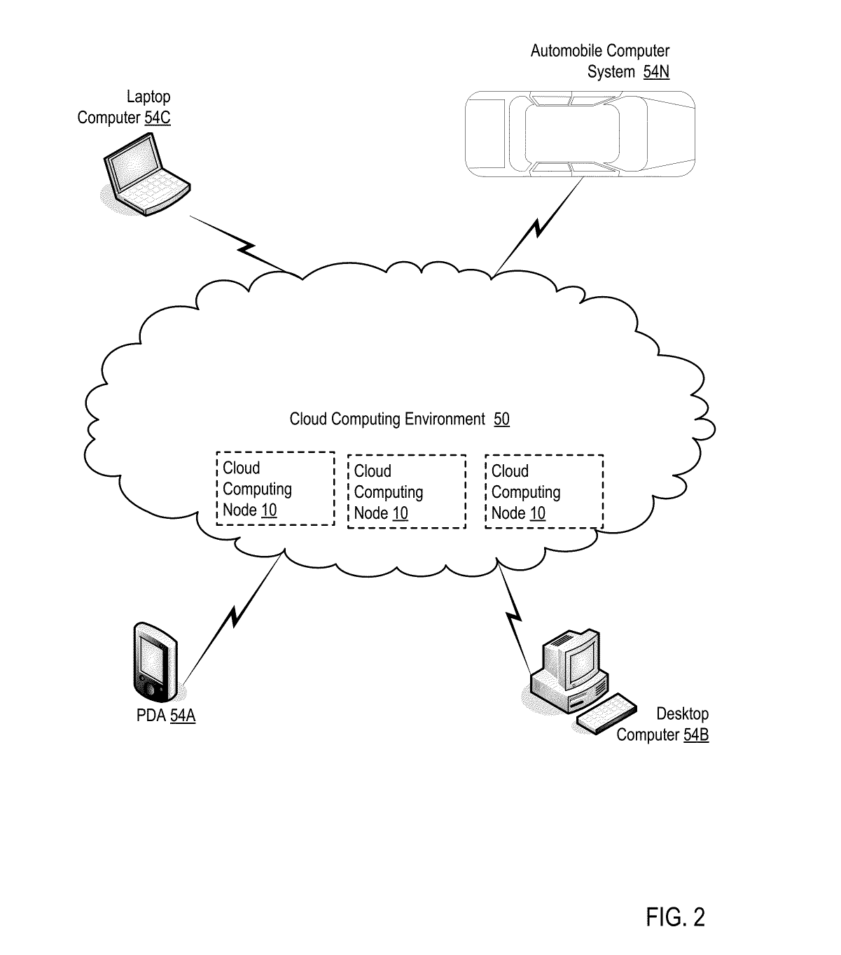

Referring now to FIG. 2, illustrative cloud computing environment (50) is depicted. As shown, cloud computing environment (50) comprises one or more cloud computing nodes (10) with which local computing devices used by cloud consumers, such as, for example, personal digital assistant (‘PDA’) or cellular telephone (54A), desktop computer (54B), laptop computer (54C), and/or automobile computer system (54N) may communicate. The cloud computing nodes (10) may communicate with one another. They may be grouped (not shown) physically or virtually, in one or more networks, such as Private, Community, Public, or Hybrid clouds as described hereinabove, or a combination thereof. This allows cloud computing environment (50) to offer infrastructure, platforms and/or software as services for which a cloud consumer does not need to maintain resources on a local computing device. It is understood that the types of computing devices (54A-N) shown in FIG. 2 are intended to be illustrative only and that computing nodes (10) and cloud computing environment (50) can communicate with any type of computerized device over any type of network and/or network addressable connection (e.g., using a web browser).

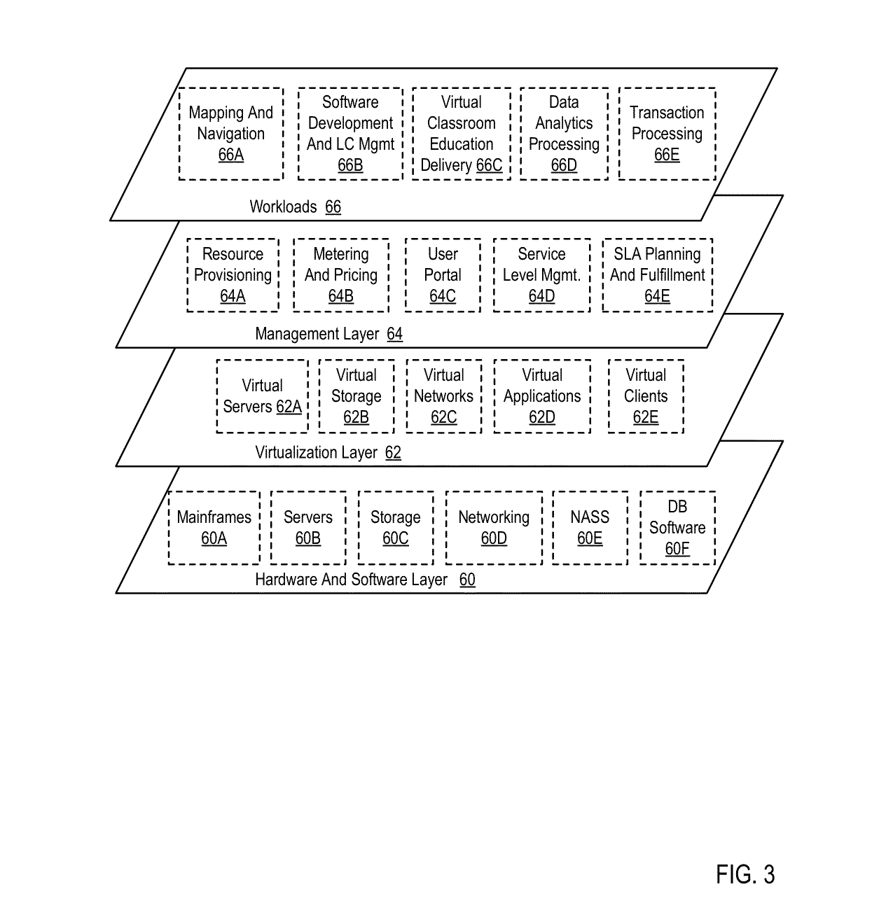

Referring now to FIG. 3, a set of functional abstraction layers provided by cloud computing environment (element 50 in FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer (60) includes hardware and software components. Examples of hardware components include mainframes (60A), in one example IBM® zSeries® systems; RISC (Reduced Instruction Set Computer) architecture based servers (60B), in one example IBM pSeries® systems; IBM xSeries® systems; IBM BladeCenter® systems; storage devices (60C); networks and networking components (60D). Examples of software components include network application server software (60E), in one example IBM WebSphere® application server software; and database software (60F), in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (62) provides an abstraction layer from which the following examples of virtual entities may be provided: virtual servers (62A); virtual storage (62B); virtual networks (62C), including virtual private networks; virtual applications (62D) and operating systems; and virtual clients (62E).

In one example, management layer (64) may provide the functions described below. Resource provisioning (64A) provides dynamic procurement of computing resources and other resources that are utilized to perform tasks within the cloud computing environment. Metering and Pricing (64B) provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal (64C) provides access to the cloud computing environment for consumers and system administrators. Service level management (64D) provides cloud computing resource allocation and management such that required service levels are met. Service Level Agreement (SLA) planning and fulfillment (64E) provides pre-arrangement for, and procurement of, cloud computing resources for which a future requirement is anticipated in accordance with an SLA.

Workloads layer (66) provides examples of functionality for which the cloud computing environment may be utilized. Examples of workloads and functions which may be provided from this layer include: mapping and navigation (66A); software development and lifecycle management (66B); virtual classroom education delivery (66C); data analytics processing (66D); and transaction processing (66E).

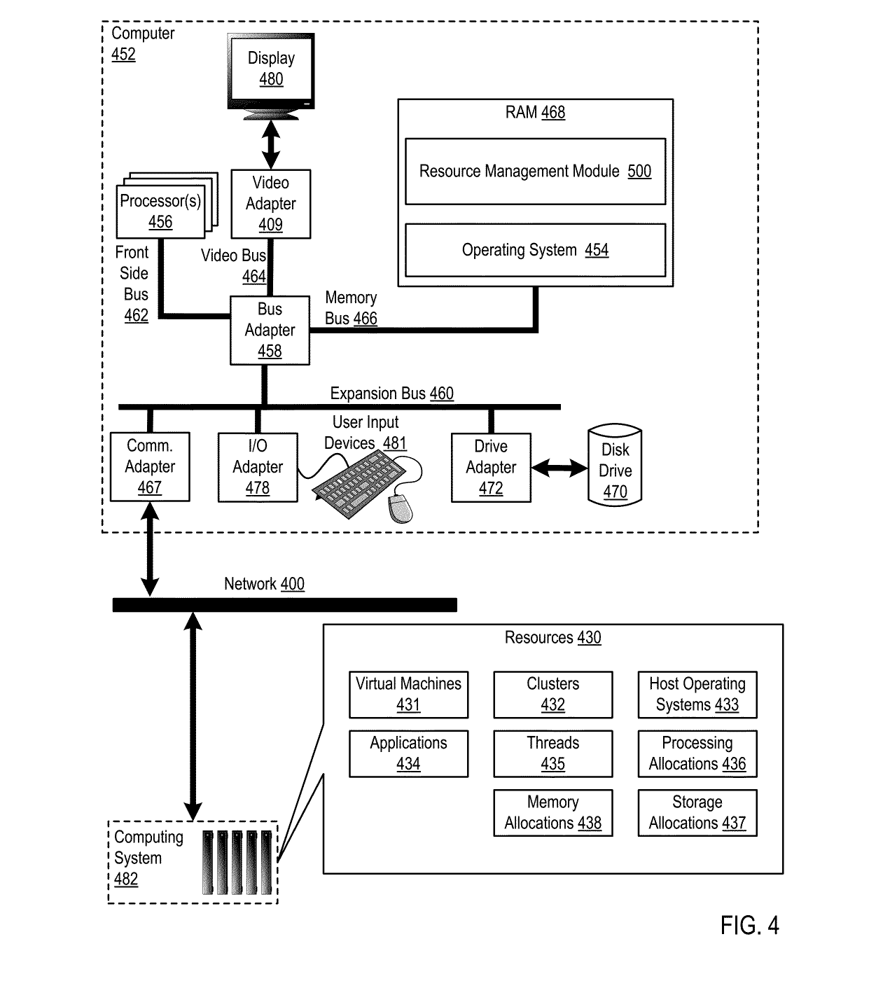

For further explanation, FIG. 4 sets forth a block diagram of automated computing machinery comprising an example computer useful in enabling capacity on demand in a computing system using a calendar according to embodiments of the present invention. The computer (452) of FIG. 4 includes at least one computer processor (456) or ‘CPU’ as well as random access memory (468) (‘RAM’) which is connected through a high speed memory bus (466) and bus adapter (458) to processor (456) and to other components of the computer (452).

Stored in RAM (468) is a resource management module (500), a module of computer program instructions that, when executed causes the computer (452) of FIG. 4 to enable capacity on demand in a computing system (482) using a calendar. The computing system (482) of FIG. 4 may be embodied as a server, a rack of blade servers in a blade center, as a virtualized system supported by underlying hardware and software resources of the cloud computing environment, and so on. That is, the computing system (482) of FIG. 4 may be a virtual construct that includes a group of allocated resources which are part of a cloud computing environment and allocated for use by a particular user. Examples of such allocated resources include but are not limited to virtual machines (431), clusters (432) of hardware devices or virtualized hardware, host operating systems (433), applications (434), threads or processes (435), processing allocations (436), storage allocations (436), memory allocations (438), and so on as will occur to readers of skill in the art. Other resources may also be included in the computing system (482) such as virtual patterns (grouping of multiple virtual resources that work together, such as VMs), virtual networks, virtual bridges, virtual applications, virtual disk as well as pools of such various resources. In the example of FIG. 4, several resources (430) may be executed, instantiated, hosted, virtualized, or implemented by other computers coupled via a data communications network (400) to the computer (452). Also, users (not shown here) may be coupled via one or more data communications network (400) to utilize the resources (430).

In the example of FIG. 4, the resource management module (500) may enable capacity on demand in a computing system (482) using a calendar in accordance with embodiments of the present invention by receiving a request to purchase capacity on demand, receiving one or more calendar entries identifying requested periods of time for additional capacity, and allocating capacity on demand in dependence upon the cumulative amount of time for capacity on demand and the requested periods of time for additional capacity.

Also stored RAM (468) of the computer (452) is an operating system (454). Operating systems useful for enabling capacity on demand in a computing system using a calendar according to embodiments of the present invention include UNIX™, Linux™, Microsoft XP™, AIX™, IBM's i5/OS™, and others as will occur to those of skill in the art. The operating systems (454) and the resource management module (500) in the example of FIG. 4 are shown in RAM (468), but many components of such software typically are stored in non-volatile memory also, such as, for example, on a disk drive (470).

The computer (452) of FIG. 4 includes disk drive adapter (472) coupled through expansion bus (460) and bus adapter (458) to the processors (456) and other components of the computer (452). Disk drive adapter (472) connects non-volatile data storage to the computer (452) in the form of the disk drive (470). Disk drive adapters useful in computers for enabling capacity on demand in a computing system using a calendar according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (452) of FIG. 4 includes one or more input/output (‘I/O’) adapters (478). I/O adapters implement user-oriented input/output through, for example, software drivers and computer hardware for controlling output to display devices such as computer display screens, as well as user input from user input devices (481) such as keyboards and mice. The example computer (452) of FIG. 4 includes a video adapter (409), which is an example of an I/O adapter specially designed for graphic output to a display device (480) such as a display screen or computer monitor. The video adapter (409) is connected to the processors (456) through a high speed video bus (464), bus adapter (458), and the front side bus (462), which is also a high speed bus.

The example computer (452) of FIG. 4 includes a communications adapter (467) for data communications with the other computers and for data communications with the data communications network (400). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for enabling capacity on demand in a computing system using a calendar according to embodiments of the present invention include modems for wired dial-up communications, Ethernet (IEEE 802.3) adapters for wired data communications, and 802.11 adapters for wireless data communications.

The arrangement of computers and other devices making up the example system illustrated in FIG. 4 are for explanation, not for limitation. Data processing systems useful according to various embodiments of the present invention may include additional databases, servers, routers, other devices, and peer-to-peer architectures, not shown in FIG. 4, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 4.

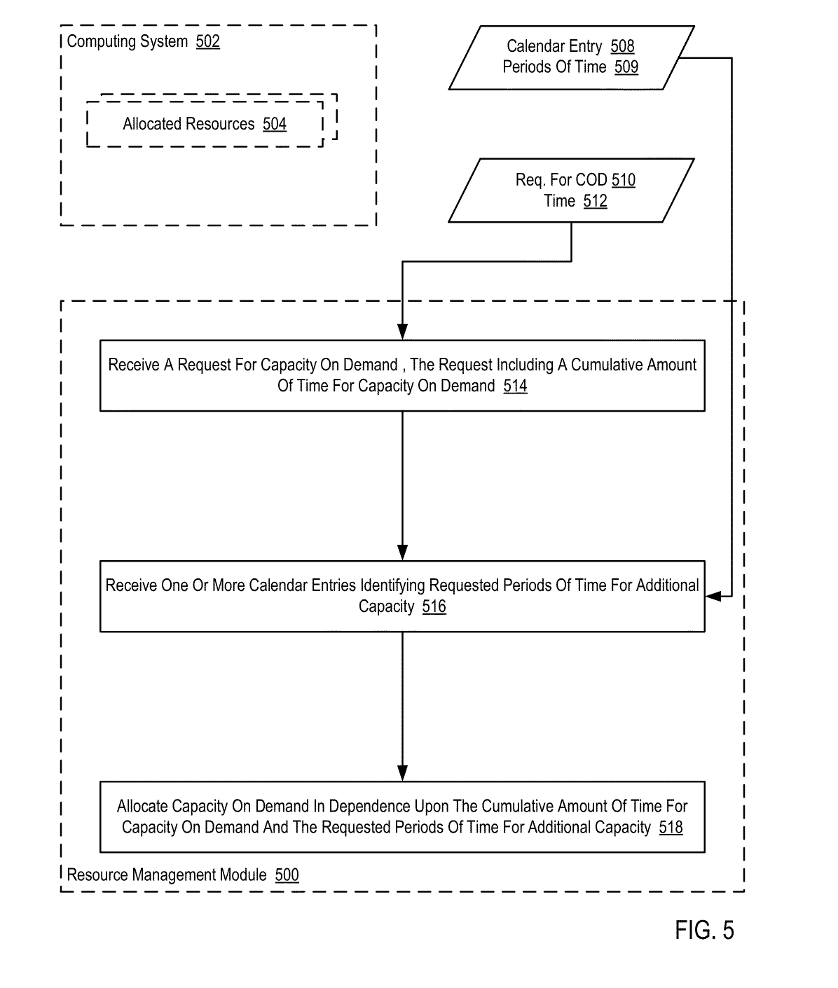

For further explanation, FIG. 5 sets forth a flow chart illustrating an example method for enabling capacity on demand in a computing system (502) using a calendar according to embodiments of the present invention. In the example method of FIG. 5, the computing system (502) may be embodied as a server, a rack of blade servers in a blade center, as a virtualized system supported by underlying hardware and software resources of the cloud computing environment, and so on. That is, the computing system (502) of FIG. 5 may be a virtual construct that includes a group of allocated resources (504) which are part of a cloud computing environment and allocated for use by a particular user.

The example method depicted in FIG. 5 is carried out, at least in part, by a resource management module (500). The resource management module (500) of FIG. 5 may be embodied as a module of computer program instructions executing on computer hardware such as a computer processor. The resource management module (500) of FIG. 5 is depicted as being separate from the computing system (502) of FIG. 5, however, readers will appreciate that the resource management module (500) may be embodied as a module of computer program instructions executing on computer hardware that is part of the computing system (502). The resource management module (500) may also be embodied as a module of computer program instructions that reside within, and are executed upon, computer hardware that is part of a cloud computing environment. For example, the resource management module (500) may be embodied as part of a cloud resource manager that allocates cloud resources to various clients of the cloud computing environment.

The example method depicted in FIG. 5 includes receiving (514), by the resource management module (500), a request (510) to purchase capacity on demand. The request (510) to purchase capacity on demand represents a request to purchase the ability to make additional capacity (e.g., additional computing resources) available at a later point in time. Consider an example in which a user of the computing system (502) anticipates that the user may need additional capacity in the form of additional RAM at some later point in time. In such an example, the request (510) to purchase capacity on demand can represent a request to purchase the ability to make additional RAM available for the user at some later point in time. The request (510) to purchase capacity on demand does not represent a request to immediately allocate, or allocate at a future date, additional RAM for use by the user. Such a request (510) to purchase capacity on demand represents a request to purchase the ability to make additional capacity available if needed. In the example method of FIG. 5, the request (510) includes a cumulative amount of time (512) for capacity on demand. The cumulative amount of time (512) for capacity on demand may be expressed in any unit of time such as, for example, the number of desired hours for capacity on demand, the number of desired days for capacity on demand, and so on.

The example method depicted in FIG. 5 also includes receiving (516), by the resource management module (500), one or more calendar entries (508) identifying requested periods (509) of time for additional capacity. In the example method of FIG. 5, the one or more calendar entries (508) may be embodied as a data structure that includes information identifying times at which a user of the computing system (502) would like to have additional capacity beyond the standard capacity of the computing system (502). The one or more calendar entries (508) identifying requested periods (509) of time for additional capacity may be received (516), for example, via a GUI presented to a user of the computing system (502) that enables a user to select dates and times at which the user of the computing system (502) would like to have additional capacity.

In the example method of FIG. 5, the requested periods (509) of time for additional capacity may include periods of time with additional capacity that are separated by periods of time during which capacity on demand is not available. Consider an example in which the user of a computing system (502) sells flowers via a website that is hosted on the computing system (502) of FIG. 5. In such an example, the website may be required to handle a higher volume of orders on days such as Valentine's Day, Mother's Day, and other holidays. As such, the user of the computing system may desire that additional capacity be made available on Valentine's Day, Mother's Day, and other holidays, such that the additional resources may be utilized by the computing system (502) to handle the expected increase in orders. During all other periods that were not identified in the one or more calendar entries (508), additional capacity is not available to the user of the computing system (502).

The example method depicted in FIG. 5 also includes allocating (518), by the resource management module (500), capacity on demand in dependence upon the cumulative amount of time (512) for capacity on demand and the requested periods (509) of time for additional capacity. In the example method of FIG. 5, allocating (518) capacity on demand may be carried out, for example, by comparing the requested periods (509) of time for capacity on demand to the cumulative amount of time (512) for additional capacity, as well as any additional amount of time for capacity on demand that a particular user may have previously purchased, to determine whether enough time has been purchased to provide capacity on demand during the requested periods (509) of time for additional capacity. In such an example, when enough time has been purchased to provide capacity on demand during the requested periods (509) of time for additional capacity, the resource management module (500) may reserve additional resources to be used by the computing system (502) as capacity on demand. Such resources may be allocated to the computing system (502) for use by the computing system (502), such that the total capacity of the computing system (502) is increased during the requested periods (509) of time for additional capacity. In the example method of FIG. 5, the resource management module (500) may allocate (518) capacity on demand by communicating with a cloud management module such a resource provisioning module and requesting that additional cloud resources be allocated for use by the computing system (502) during the requested periods (509) of time for additional capacity.

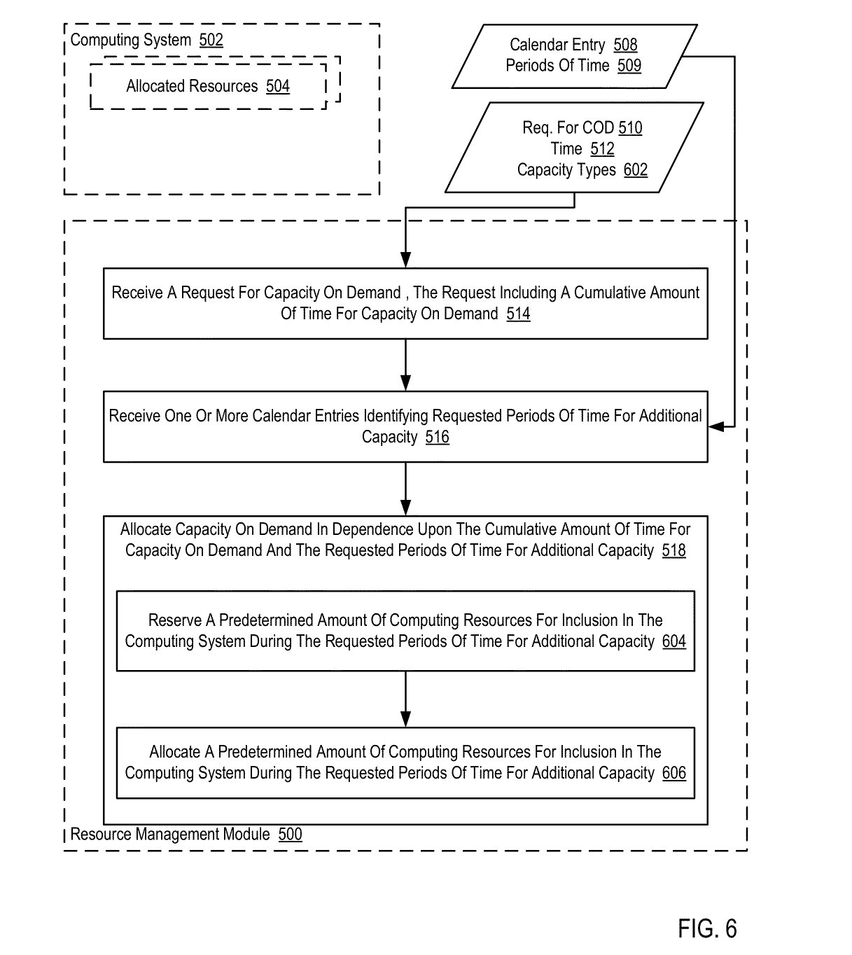

For further explanation, FIG. 6 sets forth a flow chart illustrating an additional example method for enabling capacity on demand in a computing system using a calendar according to embodiments of the present invention. The example method depicted in FIG. 6 is similar to the example method depicted in FIG. 5, as it also includes receiving (514) a request (510) to purchase capacity on demand, receiving (516) one or more calendar entries (508) identifying requested periods (509) of time for additional capacity, and allocating (518) capacity on demand in dependence upon the cumulative amount of time (512) for capacity on demand availability and the requested periods (509) of time for additional capacity.

In the example method depicted in FIG. 6, the requested periods of time (509) for additional capacity can include a plurality of periods of time for additional capacity, each of which is separated by a period of time in which additional capacity is unavailable. For example, the requested periods of time (509) for additional capacity may identify that additional capacity is desired on a specific date in each month (e.g., the 1^{st} day of each month) to carry out periodic system maintenance such as a scheduled system backup. In such an example, additional capacity is not desired on all days that are not part of the requested periods of time (509) for additional capacity, such as the 2^{nd} day of each month through the end of the month. As such, the requested periods of time (509) for additional capacity are not simply an uninterrupted period of time.

In the example method depicted in FIG. 6, the request (510) to purchase capacity on demand can include an identification of one or more types (602) of capacity. Capacity on demand may be embodied, for example, as additional processing units, additional memory, additional network bandwidth, additional processing threads, and so on. As such, the request (510) to purchase capacity on demand depicted in FIG. 6 can include an identification of one or more types (602) of capacity. The identification of one or more types (602) of capacity may be embodied, for example, as one or more field-value pairs contained in the request (510) to purchase capacity on demand, where each field-value pair includes a value that identifies the particular type of capacity to be allocated for use by the computing system (502) during the requested periods of time (509) for additional capacity.

In the example method depicted in FIG. 6, allocating (518) capacity on demand in dependence upon the cumulative amount of time (512) for capacity on demand and the requested periods (509) of time for additional capacity can include reserving (604) a predetermined amount of computing resources for inclusion in the computing system (502) during the requested periods (509) of time for additional capacity. Reserving (604) a predetermined amount of computing resources for inclusion in the computing system (502) during the requested periods (509) of time for additional capacity may be carried out, for example, by the resource management module (500) setting aside resources that reside in a cloud computing environment for use by the computing system (502) during the requested periods (509) of time for additional capacity. In such a way, a cloud manager may be aware of commitments to deliver resources in advance of actually delivering such resources.

In the example method depicted in FIG. 6, allocating (518) capacity on demand in dependence upon the cumulative amount of time (512) for capacity on demand and the requested periods (509) of time for additional capacity can also include allocating (606), by the resource management module (500), the predetermined amount of computing resources for inclusion in the computing system (502) during the requested periods (509) of time for additional capacity. Allocating (606) the predetermined amount of computing resources for inclusion in the computing system (502) during the requested periods (509) of time for additional capacity may be carried out, for example, by the resource management module (500) determining the amount of various types of computing resources required to deliver the requested amount of additional capacity to the computing system (502). The requested amount of capacity on demand may be determined, for example, by examining information contained in the request (510) for capacity on demand, in the one or more calendar entries (508), or other data structure generated by receiving input from a user specifying the amount and types of additional capacity desired by the user. Such a data structure may include, for example, information identifying the types of capacity that is needed, the amount of each type of capacity that is needed, and so on. For example, a user of the computing system (502) may indicate that the user desires to increase the capacity of the computing system (502) to include 1 additional GB of RAM is needed, 5 additional CPUs, and so on.

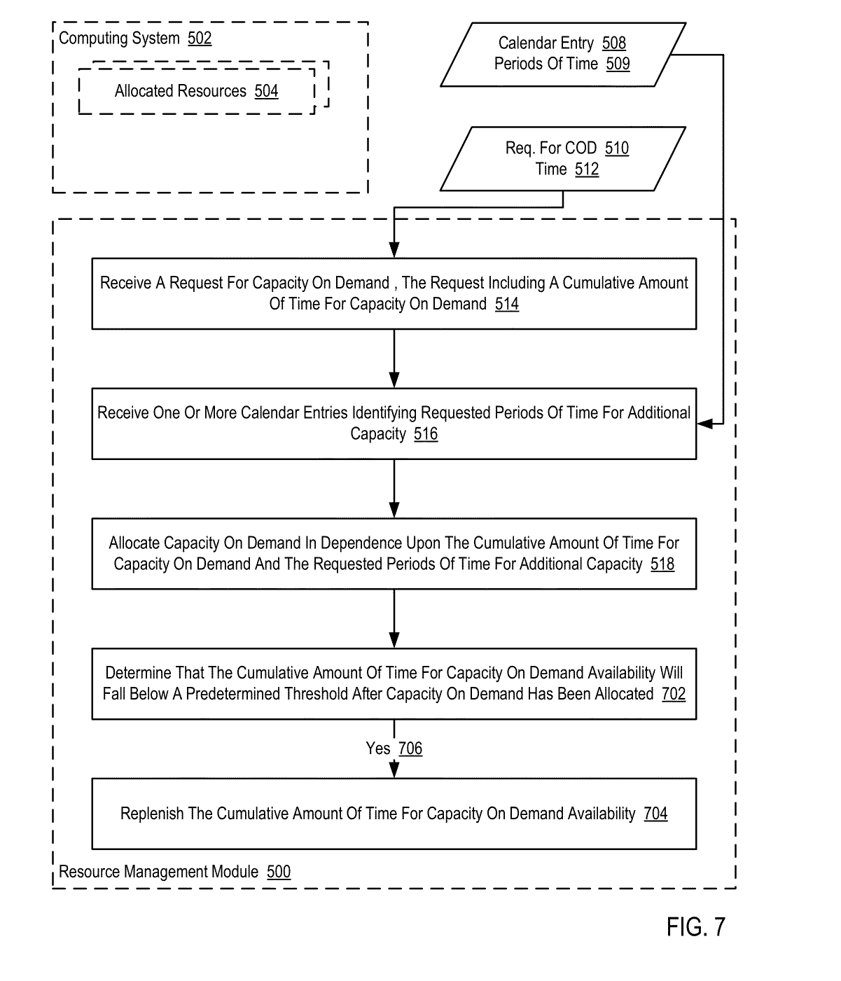

For further explanation, FIG. 7 sets forth a flow chart illustrating an additional example method for enabling capacity on demand in a computing system using a calendar according to embodiments of the present invention. The example method depicted in FIG. 7 is similar to the example method depicted in FIG. 5, as it also includes receiving (514) a request (510) to purchase capacity on demand, receiving (516) one or more calendar entries (508) identifying requested periods (509) of time for additional capacity, and allocating (518) capacity on demand in dependence upon the cumulative amount of time (512) for capacity on demand and the requested periods (509) of time for additional capacity.

The example method depicted in FIG. 7 also includes determining (702), by the resource management module (500), that the cumulative amount of time for capacity on demand will fall below a predetermined threshold after capacity on demand has been allocated (518). As described above, when a particular user issues a request (510) to purchase capacity on demand, such a request (510) may include the cumulative amount of time (512) for capacity on demand requested by the user. Upon allocating (518) capacity on demand, however, the cumulative amount of time (512) for capacity on demand requested by the user may be exhausted or otherwise below a predetermined threshold, leaving the user with a reduced ability to request additional capacity on demand. In such an example, it may be desirable for the user to purchase additional capacity on demand.

The example method depicted in FIG. 7 also includes replenishing (704), by the resource management module (500), the cumulative amount of time for capacity on demand. Replenishing (704) the cumulative amount of time for capacity on demand may be carried out in response to affirmatively (706) determining that the cumulative amount of time for capacity on demand will fall below a predetermined threshold after capacity on demand has been allocated (518). In the example method depicted in FIG. 7, replenishing (704), the cumulative amount of time for capacity on demand may be carried out, for example, by allocating a predetermined additional amount of capacity on demand to a user that initiated the original request (510) to purchase capacity on demand. In such a way, the user may continue to have capacity on demand after capacity on demand has been allocated (518) as described above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of enabling capacity on demand in a computing system using a calendar, the method comprising:
receiving, by a resource management module, a request to purchase capacity on demand, the request including a cumulative amount of time for capacity on demand;
receiving, by the resource management module, one or more calendar entries identifying requested periods of time for additional capacity; and
allocating, by the resource management module, capacity on demand in dependence upon the cumulative amount of time for capacity on demand and the requested periods of time for additional capacity.

2. The method of claim 1 wherein the requested periods of time for additional capacity includes a plurality of periods of time for additional capacity, each of which is separated by a period of time in which additional capacity is unavailable.

3. The method of claim 1 wherein the request to purchase capacity on demand includes an identification of one or more types of capacity on demand.

4. The method of claim 1 wherein allocating capacity on demand in dependence upon the cumulative amount of time for capacity on demand and the requested periods of time for additional capacity further comprises reserving a predetermined amount of computing resources for inclusion in the computing system during the requested periods of time for additional capacity.

5. The method of claim 1 wherein allocating capacity on demand in dependence upon the cumulative amount of time for capacity on demand and the requested periods of time for additional capacity further comprises allocating, by the resource management module, a predetermined amount of computing resources for inclusion in the computing system during the requested periods of time for additional capacity.

6. The method of claim 1 further comprising:
determining, by the resource management module, that the cumulative amount of time for capacity on demand will fall below a predetermined threshold after capacity on demand has been allocated; and
replenishing, by the resource management module, the cumulative amount of time for capacity on demand.

7. An apparatus for enabling capacity on demand in a computing system using a calendar, the apparatus comprising a computer processor, a computer memory operatively coupled to the computer processor, the computer memory having disposed within it computer program instructions that, when executed by the computer processor, cause the apparatus to carry out the steps of:
receiving, by a resource management module, a request to purchase capacity on demand, the request including a cumulative amount of time for capacity on demand;
receiving, by the resource management module, one or more calendar entries identifying requested periods of time for additional capacity; and
allocating, by the resource management module, capacity on demand in dependence upon the cumulative amount of time for capacity on demand and the requested periods of time for additional capacity.

8. The apparatus of claim 7 wherein the requested periods of time for additional capacity includes a plurality of periods of time for additional capacity, each of which is separated by a period of time in which additional capacity is unavailable.

9. The apparatus of claim 7 wherein the request to purchase capacity on demand includes an identification of one or more types of capacity on demand.

10. The apparatus of claim 7 wherein allocating capacity on demand in dependence upon the cumulative amount of time for capacity on demand and the requested periods of time for additional capacity further comprises reserving a predetermined amount of computing resources for inclusion in the computing system during the requested periods of time for additional capacity.

11. The apparatus of claim 7 wherein allocating capacity on demand in dependence upon the cumulative amount of time for capacity on demand and the requested periods of time for additional capacity further comprises allocating, by the resource management module, a predetermined amount of computing resources for inclusion in the computing system during the requested periods of time for additional capacity.

12. The apparatus of claim 7 further comprising computer program instructions that, when executed by the computer processor, cause the apparatus to carry out the steps of:
determining, by the resource management module, that the cumulative amount of time for capacity on demand will fall below a predetermined threshold after capacity on demand has been allocated; and
replenishing, by the resource management module, the cumulative amount of time for capacity on demand.

13. A computer program product for enabling capacity on demand in a computing system using a calendar, the computer program product disposed upon a computer readable medium, the computer program product comprising computer program instructions that, when executed, cause a computer to carry out the steps of:
receiving, by a resource management module, a request to purchase capacity on demand, the request including a cumulative amount of time for capacity on demand;
receiving, by the resource management module, one or more calendar entries identifying requested periods of time for additional capacity; and
allocating, by the resource management module, capacity on demand in dependence upon the cumulative amount of time for capacity on demand and the requested periods of time for additional capacity.

14. The computer program product of claim 13 wherein the requested periods of time for additional capacity includes a plurality of periods of time for additional capacity, each of which is separated by a period of time in which additional capacity is unavailable.

15. The computer program product of claim 13 wherein the request to purchase capacity on demand includes an identification of one or more types of capacity on demand.

16. The computer program product of claim 13 wherein allocating capacity on demand in dependence upon the cumulative amount of time for capacity on demand and the requested periods of time for additional capacity further comprises reserving a predetermined amount of computing resources for inclusion in the computing system during the requested periods of time for additional capacity.

17. The computer program product of claim 13 wherein allocating capacity on demand in dependence upon the cumulative amount of time for capacity on demand and the requested periods of time for additional capacity further comprises allocating, by the resource management module, a predetermined amount of computing resources for inclusion in the computing system during the requested periods of time for additional capacity.

18. The computer program product of claim 13 further comprising computer program instructions that, when executed, cause the computer to carry out the steps of:
determining, by the resource management module, that the cumulative amount of time for capacity on demand will fall below a predetermined threshold after capacity on demand has been allocated; and
replenishing, by the resource management module, the cumulative amount of time for capacity on demand.

19. The computer program product of claim 13 wherein the computer readable medium comprises a signal medium.

20. The computer program product of claim 13 wherein the computer readable medium comprises a storage medium.
